(19) United States
(12) Patent Application Publication
(10) Pub. No.: US 2006/0152514 A1
(43) Pub. Date: Jul. 13, 2006

(54) Host device, display device and display system

(75) Inventors: Jin-hun Kim, Gyeonggi-do (KR); Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/290,447

(22) Filed: Dec. 1, 2005

(30) Foreign Application Priority Data
Jan. 12, 2005 (KR) 2005-0003001

(51) Int. Cl. G06F 15/16

(52) U.S. Cl. 345/503

(57) ABSTRACT

The present invention relates to a host device supporting digital packet video link (DPVL) standards, comprising a plurality of host interfaces, a host frame buffer for storing video data, and a host controller for dividing a detected update area into a plurality of divided update areas on the basis of the DPVL standards, generating a divided DPVL packet corresponding to each divided update area by reading out the video data corresponding to each divided update area from the host frame buffer, and outputting the divided DPVL packet through the host interface corresponding to the divided DPVL packet.

### CROSS-REFERENCE TO RELATED APPLICATIONS

This application claims the benefit under 35 U.S.C. 119(a) of Korean Patent Application No. 2005-0003001, filed on Jan. 12, 2005, in the Korean Intellectual Property Office, the entire contents of which are hereby incorporated herein by reference.

### BACKGROUND OF THE INVENTION

1. Field of the Invention

The present invention relates to a host device, a display device and a display system. More particularly, the present invention relates to a host device, a display device and a display system in which a clock frequency is decreased to meet digital packet video link (DPVL) standards, so that transmission speed is enhanced.

2. Description of the Related Art

As technology for manufacturing a display device such as a monitor has improved, there is a tendency to provide the display device with high specifications such as a high density, a large number of pixels and the like.

However, there are various limitations to achieving wide use of this high specification display device. One of the limitations is a requirement for an interface between the display device and a host device due to the display device requiring a high transmission bandwidth as compared with an existing display device.

To satisfy the interface requirement for the high specification display device, digital packet video link (DPVL) standards have been proposed by video electronics standard associations (VESA).

FIG. 1 is a control block diagram of a conventional display system supporting the DPVL standards. As shown therein, a display system supporting the DPVL standards comprises a host device 110 and a display device 130.

The host device 110 comprises a frame buffer 113, a graphic engine 111 for generating video data and storing the video data in the frame buffer 113 in units of frames, and a host controller 112 for reading out the video data corresponding to an update area (UA) (refer to FIG. 2) within a current frame from the frame buffer 113 and outputting a DPVL packet. Here, the update area UA indicates a changed image within the current frame as compared with a previous frame.

The display device 130 comprises a frame buffer 133, and a display controller 132 for detecting the video data out of the DPVL packet received from the host device 110, storing the video data in the frame buffer 133, and controlling a display module 131 to display an image based on the video data corresponding to one frame stored in the frame buffer 133.

According to the DPVL standards, the host device 110 and the display device 130 are connected through a digital video interface (DVI) standard proposed by a digital display working group (DDWG).

Further, the DPVL standards minimize the amount of data that is encoded and decoded while being transmitted from the host device 110 to the display device 130, thereby lowering a clock frequency and enabling it to be proportional to the amount of data.

However, in a case that the update area UA is relatively large as shown in FIG. 2, the amount of the data transmitted from the host device 110 to the display device 130 also increases, so that it is difficult to enhance transmission speed on the basis of the DPVL standards using a method of decreasing the amount of the video data transmitted from the host device 110 to the display device 130.

### SUMMARY OF THE INVENTION

Accordingly, it is an object of the present invention to provide a host device, a display device and a display system, in which a clock frequency is decreased, to meet digital packet video link (DPVL) standards, so that transmission speed is enhanced.

Exemplary aspects and/or advantages of the invention will be set forth in part in the description which follows and, in part, will be obvious from the description, or may be learned by practice of the invention.

The foregoing and/or other exemplary aspects of the present invention are achieved by providing a host device supporting DPVL standards, comprising a plurality of host interfaces, a host frame buffer for storing video data, and a host controller for dividing a detected update area into a plurality of divided update areas on the basis of the DPVL standards, generating a divided DPVL packet corresponding to each divided update area by reading out the video data corresponding to each divided update area from the host frame buffer, and outputting the divided DPVL packet through the host interface corresponding to the divided DPVL packet.

According to an exemplary aspect of the present invention, the host controller comprises a plurality of packet generator for generating each divided DPVL packet; and a packet controller for controlling the packet generators for generating the divided DPVL packets, respectively.

According to an exemplary aspect of the present invention, the host controller controls the DPVL packet and the divided DPVL packet to include information about whether the DPVL packet output through the host interface comprises the divided DPVL packet.

The foregoing and/or other exemplary aspects of the present invention are achieved by providing a display device supporting DPVL standards, comprising a display module for displaying an image thereon, a plurality of display interfaces for receiving a DPVL packet based on the DPVL standards, a display frame buffer for storing video data as a unit of frames; and a display controller for determining whether the DPVL packets received through the display interfaces comprise divided DPVL packets to form one frame, storing the video data in the display frame buffer by detecting the video data out of the divided DPVL packet if it is determined that the DPVL packets comprise the divided DPVL packets, and controlling the display module to display an image based on the video data corresponding to a current frame stored in the frame buffer.

According to an exemplary aspect of the present invention, the display controller comprises a plurality of packet decoders for detecting the video data out of the DPVL packet received through each display interface, and a decoder controller for storing the video data detected by each packet decoder in the display frame buffer to form one frame when the DPVL packets received through the display interfaces comprise the divided DPVL packets.

The foregoing and/or other exemplary aspects of the present invention are achieved by providing a display system supporting DPVL standards, comprising a host device comprising a plurality of host interfaces, a host frame buffer for storing video data, and a host controller for dividing a detected update area into a plurality of divided update areas on the basis of the DPVL standards, generating a divided DPVL packet corresponding to each divided update area by reading out the video data corresponding to each divided update area from the host frame buffer, and outputting the divided DPVL packet through the host interface corresponding to the divided DPVL packet; and a display device comprising a display module for displaying an image thereon, a plurality of display interfaces connected to the respective host interfaces, a display frame buffer for storing video data as a unit of frames, and a display controller for detecting the video data corresponding to each divided update area out of the divided DPVL packet received through each display interface, storing the detected video data in the display frame buffer, and controlling the display module to display an image based on the video data corresponding to a current frame stored in the frame buffer.

According to an exemplary aspect of the present invention, the host controller controls the DPVL packet and the divided DPVL packet for including information about whether the DPVL packet output through the host interface comprises the divided DPVL packet, and the display controller for determining whether the DPVL packet received through the display interface comprises the divided DPVL packet on the basis of the information about whether the DPVL packet comprises the divided DPVL packet, which is recorded in the DPVL packet and/or the divided DPVL packet received through the display interface.

### BRIEF DESCRIPTION OF THE DRAWINGS

These and other exemplary aspects and advantages of the present invention will become apparent and more readily appreciated from the following description of the embodiments, taken in conjunction with the accompany drawings of which:

FIG. 1 is a control block diagram of a conventional display system supporting digital packet video link (DPVL) standards;

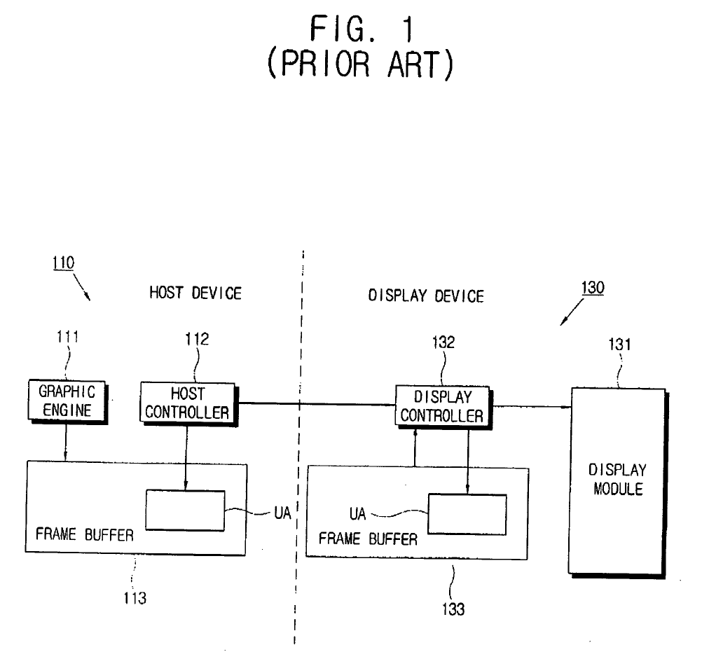

FIG. 2 is a view showing an update area according to the digital packet video link (DPVL) standards; and

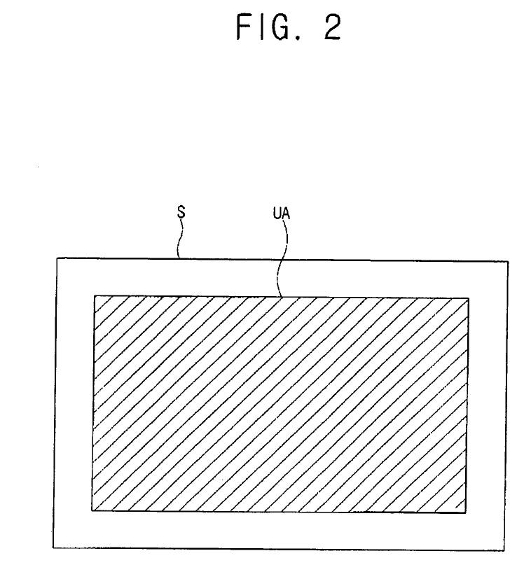

FIG. 3 is a control block diagram of a display system according to an exemplary embodiment of the present invention supporting the DPVL standards.

Throughout the drawings, the same or similar elements are denoted by the same reference numerals.

### DETAILED DESCRIPTION OF EXEMPLARY EMBODIMENTS

Reference will now be made in detail to exemplary embodiments of the present invention, examples of which are illustrated in the accompanying drawings.

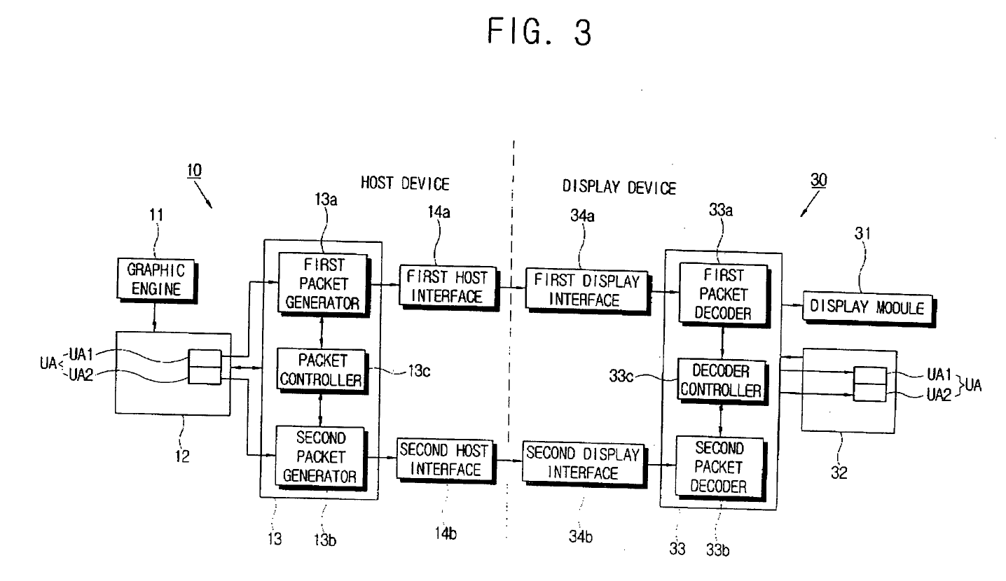

A display system according to an exemplary embodiment of the present invention supports digital packet video link (DPVL) standards by video electronics standard associations (VESA). The display system comprises a host device 10 and a display device 30 as shown in FIG. 3.

The host device 10 comprises a plurality of interfaces, a graphic engine 11, a host frame buffer 12, and a host controller 13. Here, the host device 10 comprises two host interfaces 14a and 14b by way of example (refer to FIG. 3), but is not limited to two host interfaces.

The graphic engine 11 generates video data to be displayed as an image on the display device 30, and stores the video data in the host frame buffer 12 as a unit of frames.

The first host interface 14a and the second host interface 14b may be variously configured to support the DPVL standards. In this exemplary embodiment, the first and second host interfaces 14a and 14b support a digital video interface (DVI) of a digital display working group (DDWG). However, the host interfaces 14a and 14b can also be adapted to support a high definition multimedia interface (HDMI) standard.

The host controller 13 detects an update area (UA) including the video data that changed between a current frame and a previous frame on the basis of the video data stored in the host frame buffer 12.

Further, the host controller 13 divides the detected update area UA into a plurality of divided update areas UA1 and UA2. In this exemplary embodiment, the host controller 13 divides the detected update area UA into two divided update areas UA1 and UA2 by way of example, which will be called a first divided update area UA1 and a second divided update area UA2.

Also, the host controller 13 reads out the video data corresponding to the first and second divided update areas UA1 and UA2 from the host frame buffer 12, and generates a first divided DPVL packet and a second divided DPVL packet corresponding to the first and second divided update areas UA1 and UA2 on the basis of the DPVL standards, respectively.

Then, the host controller 13 outputs the first and second divided DPVL packets to the display device 30 through the first and second host interfaces 14a and 14b, respectively.

According to an exemplary embodiment of the present invention, the host controller 13 further comprises a first packet generator 13a, a second packet generator 13b, and a packet controller 13c for controlling the first and second packet generators 13a and 13b.

The first packet generator 13a encodes the video data read from the host frame buffer 12 corresponding to the first divided update area UA1, thereby generating the first divided DPVL packet. Here, the first divided DPVL packet generated by the first packet generator 13a is output to the display device 30 through the first host interface 14a.

The second packet generator 13b encodes the video data read from the host frame buffer 12 corresponding to the second divided update area UA2, thereby generating the second divided DPVL packet. Here, the second divided DPVL packet generated by the second packet generator 13b is output to the display device 30 through the second host interface 14b.

The packet controller 13c controls the first and second packet generators 13a and 13b to generate the first and second divided DPVL packets. As the first and second divided update areas UA1 and UA2 are respectively generated by the first and second packet generators 13a and 13b, the amount of data included in each DPVL packet is decreased.

Further, the packet controller 13c controls the DPVL packet to include information about whether the DPVL packet is divided or not when the DPVL packet is generated by the first and second packet generators 13a and 13b. Hence, the host controller 13 provides the display device 30 with the information about whether or not the DPVL packet output through the first host interface 14a and/or the second host interface 14b is the divided DPVL packet.

Here, the information about whether the DPVL packet is the divided DPVL packet is recorded in an extra space of a header provided in the DPVL packet.

Meanwhile, the display device 30 according to an exemplary embodiment of the present invention comprises a display module 31, a plurality of display interfaces 34a and 34b, a display frame buffer 32, and a display controller 33.

The display module 31 displays an image thereon on the basis of a video signal output from the display controller 33. Here, the display module 31 can comprise various modules such as a liquid crystal display (LCD) module, a plasma display panel (PDP) module, and so on as long as it can display an image based on the video signal output from the display controller 33.

The display frame buffer 32 has a storage space to store the video data corresponding to one frame. Here, the display frame buffer 32 satisfies the DPVL standards of VESA.

The display interfaces 34a and 34b comprise a first display interface 34a and a second display interface 34b connected to the first host interface 14a and the second host interface 14b, respectively. Here, the first display interface 34a and the second display interface 34b may be variously configured to support the DPVL standards. Further, the first and second display interfaces 34a and 34b support the DVI standard like the first and second host interfaces 14a and 14b.

The display controller 33 determines whether the DPVL packets received through the first and second display interfaces 34a and 34b are the first and second divided DPVL packets to form one frame. Here, the display controller 33 determines whether the DPVL packets are the first and second divided DPVL packets on the basis of the information recorded in the DPVL packets received through the first and second display interfaces 34a and 34b.

When it is determined that the DPVL packet received through the first display interface 34a comprises the first and second divided DPVL packets, the display controller 33 detects the video data from each of the first and second divided DPVL packets, and stores the detected video data in the display frame buffer 32.

Further, the display controller 33 controls the display module 31 to display an image thereon on the basis of total video data corresponding to the current frame stored in the display frame buffer 32.

Here, the display controller 33 according to an exemplary embodiment of the present invention comprises a first packet decoder 33a, a second packet decoder 33b, and a decoder controller 33c for controlling the first and second packet decoders 33a and 33b.

The first packet decoder 33a decodes the DPVL packet received through the first display interface 34a, e.g., decodes the first divided DPVL packet, thereby detecting the video data.

The second packet decoder 33b decodes the DPVL packet received through the second display interface 34b, e.g., decodes the second divided DPVL packet, thereby detecting the video data.

The decoder controller 33c determines whether the DPVL packets received through the respective display interfaces 34a and 34b are the divided DPVL packet. When it is determined that the received DPVL packets are the divided DPVL packet, the video data detected by the first and second packet decoders 33a and 33b is stored to form one frame in the display frame buffer 32.

Thus, the first and second divided DPVL packets corresponding to one update area are respectively processed by the first and second packet decoders 33a and 33b, thereby decreasing the amount of the video data corresponding to one DPVL packet processed in the display device 30.

As described above, this exemplary embodiment of the present invention provides a host device, a display device and a display system, in which a clock frequency is decreased to meet DPVL standards so that transmission speed is enhanced.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A host device supporting digital packet video link (DPVL) standards, comprising:
a plurality of host interfaces;
a host frame buffer for storing video data; and
a host controller for dividing a detected update area into a plurality of divided update areas on the basis of the DPVL standards, generating a divided DPVL packet corresponding to each divided update area by reading out the video data corresponding to each divided update area from the host frame buffer, and outputting the divided DPVL packet through the host interface corresponding to the divided DPVL packet.

2. The host device according to claim 1, wherein the host controller comprises:
a plurality of packet generator for generating each divided DPVL packet; and
a packet controller for controlling the packet generators for generating the divided DPVL packets, respectively.

3. The host device according to claim 1, wherein the host controller controls the DPVL packet and the divided DPVL packet to include information about whether the DPVL packet output through the host interface comprises the divided DPVL packet.

4. The host device according to claim 1, wherein the host interfaces support a digital video interface (DVI) standard.

5. The host device according to claim 1, wherein the host interfaces support a high definition multimedia interface (HDMI) standard.

6. A display device supporting digital packet video link (DPVL) standards, comprising:
a display module for displaying an image thereon;
a plurality of display interfaces for receiving a DPVL packet based on the DPVL standards;
a display frame buffer for storing video data; and
a display controller for determining whether the DPVL packets received through the display interfaces comprise divided DPVL packets to form one frame, storing the video data in the display frame buffer by detecting the video data out of the divided DPVL packet if it is determined that the DPVL packets comprise the divided DPVL packets, and controlling the display module to display an image based on the video data about a current frame stored in the frame buffer.

7. The display device according to claim 6, wherein the display controller comprises:
a plurality of packet decoders for detecting the video data out of the DPVL packet received through each display interface; and
a decoder controller for storing the video data detected by each packet decoder in the display frame buffer to form one frame when the DPVL packets received through the display interfaces comprise the divided DPVL packets.

8. The display device according to claim 6, wherein the video data is stored as a unit of a frame.

9. The display device according to claim 6, wherein the display module comprises a liquid crystal display.

10. The display device according to claim 6, wherein the display module comprises a plasma display panel.

11. The display device according to claim 6, wherein the display interfaces support a digital video interface (DVI) standard.

12. The display device according to claim 6, wherein the display interfaces support a high definition multimedia interface (HDMI) standard.

13. A display system supporting digital packet video link (DPVL) standards, comprising:
a host device comprising a plurality of host interfaces, a host frame buffer for storing video data, and a host controller for dividing a detected update area into a plurality of divided update areas on the basis of the DPVL standards, generating a divided DPVL packet corresponding to each divided update area by reading out the video data corresponding to each divided update area from the host frame buffer, and outputting the divided DPVL packet through the host interface corresponding to the divided DPVL packet; and
a display device comprising a display module for displaying an image thereon, a plurality of display interfaces connected to the respective host interfaces, a display frame buffer for storing video data, and a display controller for detecting the video data corresponding to each divided update area out of the divided DPVL packet received through each display interface, storing the detected video data in the display frame buffer, and controlling the display module to display an image based on the video data about a current frame stored in the frame buffer.

14. The display system according to claim 13, wherein the host controller controls the DPVL packet and the divided DPVL packet to include information about whether the DPVL packet output through the host interface comprises the divided DPVL packet, and
the display controller determines whether the DPVL packet received through the display interface comprises the divided DPVL packet on the basis of the information about whether the DPVL packet comprises the divided DPVL packet, which is recorded in the DPVL packet and/or the divided DPVL packet received through the display interface.

15. The display system according to claim 13, wherein the video data is stored as a unit of a frame.

16. The display system according to claim 13, wherein the display module comprises a liquid crystal display.

17. The display system according to claim 13, wherein the display module comprises a plasma display panel.

18. The display system according to claim 13, wherein the display interfaces support a digital video interface (DVI) standard.

19. The display system according to claim 13, wherein the display interfaces support a high definition multimedia interface (HDMI) standard.

20. A method of supporting digital packet video link (DPVL) standards, comprising:
storing video data; and
dividing a detected update area into a plurality of divided update areas on the basis of the DPVL standards, generating a divided DPVL packet corresponding to each divided update area by reading out the video data corresponding to each divided update area from the host frame buffer, and outputting the divided DPVL packet through a host interface corresponding to the divided DPVL packet.
